(19) United States
(12) Patent Application Publication
(10) Pub. No.: US 2023/0230141 A1
(43) Pub. Date: Jul. 20, 2023

(54) METHOD AND SYSTEM FOR RECOMMENDING PRODUCTS BASED ON COLLABORATIVE FILTERING BASED ON NATURAL LANGUAGE PROGRAMMING ANALOGY

(71) Applicant: Aman SOHANE, Bangalore (IN)

(72) Inventor: Aman SOHANE, Bangalore (IN)

(21) Appl. No.: 17/580,479

(22) Filed: Jan. 20, 2022

(51) Int. Cl. G06Q 30/06; G06N 20/00

(52) U.S. Cl. CPC G06Q 30/0631; G06N 20/00

(57) ABSTRACT

The present method provides a method and system for recommending products based on collaborative filtering using analogy based on natural language programming using auto machine learning algorithm. The recommendation is made for a set of tasks, such as recommendation for purchase, product display for the user or recommendation for complimentary products. The method uses natural language programming-based analogy to create data models for collaborative filtering. Further, multi armed bandit framework is used to select the data model for each application.

### TECHNICAL FIELD OF THE INVENTION

The present invention relates to a method and system for recommending products to a user. More specifically, the invention relates to user action prediction based on collaborative filtering algorithm in analogy with natural language processing concepts.

### BACKGROUND

One of the most sought-after areas of implementation of machine learning algorithms has been in recommender systems. Recommender systems are widely used in multiple areas today, including e-commerce, media, sales, among others. One of the methods of recommender systems is collaborative filtering, wherein similarities between users and products is simultaneously used to provide recommendations. While natural language programming has widely been associated with content-based filtering, some research has been done on creating a collaborative filtering-based data model based on natural language programming concepts.

Collaborative filtering methods face challenges associated with inability to adapt to new users. These methods hence cannot be used in a session-based environment. Most collaborative algorithms require computing recommendations in some offline batch processes, which cannot be adapted with user interactions. Also, the optimization based on metrices such as purchase, add to cart and view is not very straightforward for collaborative filtering methods. Deploying a collaborative filtering-based solution hence requires careful fine tuning and data analysis.

Another challenge with collaborative filtering methods is the inability to create an auto-ML model that can be applied across multiple domains.

Dynamic optimization methods such as multi armed bandits (MAB) solve this issue by trying various things and then recommending with what works best with actual measurements. The invention thus proposes a combination of these models with MAB to solve the problem of delivering recommendations dynamically for multiple domains and use cases without intervention.

### SUMMARY OF THE INVENTION

In one aspect, a method of predicting an event associated with a user action using a machine learning process is provided. The method includes the step of dynamically identifying a type of a task for prediction. The method includes the step of creating a set of product embeddings for a set of products. The method includes the step of creating a set of user vectors comprising one or more elements of a product, an action, and a time. The method includes the step of categorizing the set of user actions into one or more categories of a purchase, a view and an add to a cart based on each action associated with a respective time. The method includes the step of creating one more than one data models by calculating a temporal weightage based on a time difference between an event, an event output, and a forgetting factor, for training the one or more data models based on a set of categorized actions, aggregating a set of user vectors based on a feed forward network and a temporal weightage. The method includes the step of modifying a training algorithm of the set of data models based on a specified type of action. The method includes the step of formulating the one or more data models based on a natural language programming-based design. The product is modelled as a word in an analogy with the natural language programming-based design, the user's events during a session are modelled as a sentence in the analogy with the natural language programming-based design. The user's history is modelled as a paragraph in analogy with the natural language programming-based design. The user session is classified in the analogy with a sentiment analysis operation in the natural language programming-based design to identify a probability of a purchase for the session. The data model is pretrained and finetuned based on oner or more events of the views and the clicks to identify a plurality of product similarities, finetuning the one or more model based on the events of the purchase and a recent data. The method includes the step of predicting a probability of a next product to be purchased or liked as an output by calculating a dot product and a SoftMax of user vectors and a set of product embeddings. The method includes the step of using a multi armed bandit framework for an automating selection of each data model based on a type of task and a utilized machine learning model and optimizing a final recommendation based a selected data model.

### BRIEF DESCRIPTION OF THE DRAWINGS

FIG. 1 illustrates a system for providing recommendations in accordance with the present invention.

FIG. 2 depicts a flow chart of the steps performed in accordance with the present invention.

FIG. 3 illustrates another example process, according to some embodiments.

The Figures described above are a representative set and are not exhaustive with respect to embodying the invention.

### DESCRIPTION

Disclosed are a system, method, and article of manufacture for recommending products based on collaborative filtering based on natural language programming analogy. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,“an embodiment,”one example,’ or similar language means that a particular feature, structure, or characteristic described in connection with the embodiment is included in at least one embodiment of the present invention. Thus, appearances of the phrases ‘in one embodiment,’ in an embodiment,' and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Example definitions for some embodiments are now provided.

Collaborative filtering is a technique used by recommender systems. Collaborative filtering can use similarities between entities simultaneously to provide recommendations. In this way, collaborative filtering models can recommend an item to an entity A based on the interests of a similar entity B. Various embeddings can be learned automatically.

Multi-armed bandit problem is a problem in which a fixed limited set of resources must be allocated between competing-alternative choices in a way that maximizes their expected gain, when each choice's properties are only partially known at the time of allocation, and may become better understood as time passes or by allocating resources to the choice This can include stochastic scheduling. A multi-armed bandit model can include an agent that simultaneously attempts to acquire new knowledge (e.g. the exploration aspect) and optimize their decisions based on existing knowledge (e.g. the exploitation aspect). The agent attempts to balance these competing tasks in order to maximize their total value over the period of time considered. A multi-armed bandit model can balance reward maximization based on the knowledge already acquired with attempting new actions to further increase knowledge. A multi-armed bandit model can be used to control dynamic allocation of resources to different projects.

Natural-language programming (NLP) is an ontology-assisted way of programming in terms of natural-language sentences. A structured document with content, sections, and subsections for explanations of sentences forms a NLP document (e.g. an NLP computer program, etc.).

Recommender system can include a subclass of information filtering system that seeks to predict the rating or preference a user would give to an item. Recommender systems can make use of various systems (e.g. collaborative filtering, content-based filtering, knowledge-based systems, etc.). Collaborative filtering approaches build a model from a user's past behavior as well as similar decisions made by other users. The model can then be used to predict items (and/or ratings for items) that the user may have an interest in.

Softmax function is a generalization of the logistic function to multiple dimensions. It can be used in multinomial logistic regression and is often used as the last activation function of a neural network to normalize the output of a network to a probability distribution over predicted output classes (e.g. based on Luce's choice axiom).

Thompson sampling is a heuristic for choosing actions that addresses the exploration-exploitation dilemma in the multi-armed bandit problem. It consists of choosing the action that maximizes the expected reward with respect to a randomly drawn belief.

These definitions are provided by way of example and can be used with the systems and methods provided infra to implement various embodiments

Example Computer Architecture and Systems

The present invention provides a method and system for recommendation based on collaborative filtering methods, based on natural language processing concepts. The invention further uses multi armed bandits for selecting the data model for each application.

The systems described herein can be used for predicting event associated with a user action using auto-machine learning algorithm. The problem formulation is based on the concepts of natural language processing, wherein a product is inferred as a word, a customer session or customer session history is inferred as a sentence and the customer's history is inferred as a paragraph, in analogy with natural language programming. A data model is then formulated based on the above analogy, wherein functional modifications are made to accommodate additional information available in a recommender system problem, such as event type (e.g. purchase, view etc.), time of event, recency of the event. Also, algorithmic modifications are made to take into account the aspects associated with data augmentation (e.g. amount of data might be limited), regularization (e.g. amount of interesting data like purchase events are limited), non-stationarity of distribution (e.g. temporal effects like trends).

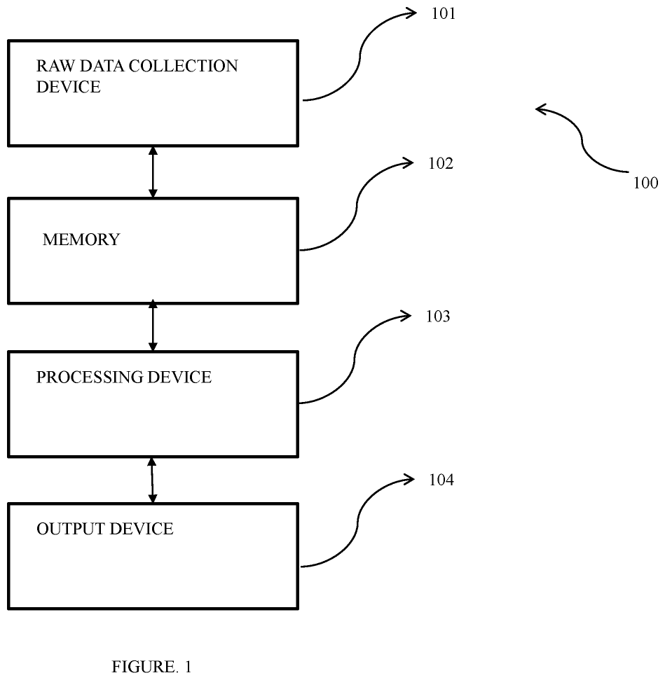

FIG. 1 illustrates a system 100 for providing the recommendations in accordance with the present invention. Raw data collection device 101 represents a raw data collection device which collects data from multiple sources. The data comprises of information including, but not limited to, products and users or customers. The data about products comprises information regarding product embeddings and events associated with the product associated with a time and action. The data about users comprises information regarding the user's choices, past purchases or sessions, products viewed or added to cart or user's feedback and information such as session cookies. The data also includes information about the products trending in the market, purchase patterns etc. from multiple sources.

Memory 102 represents a memory where the data input is stored, along with storing the source code or algorithm in accordance with the present invention.

Processing device 103 represents a processing device to execute the algorithm based on the data received by the raw data collection device 101.

Output device 104 represents an output device which displays or presents or communicates the data in form of recommendations, based on the result of the processing performed by processing device 103.

Example Methods

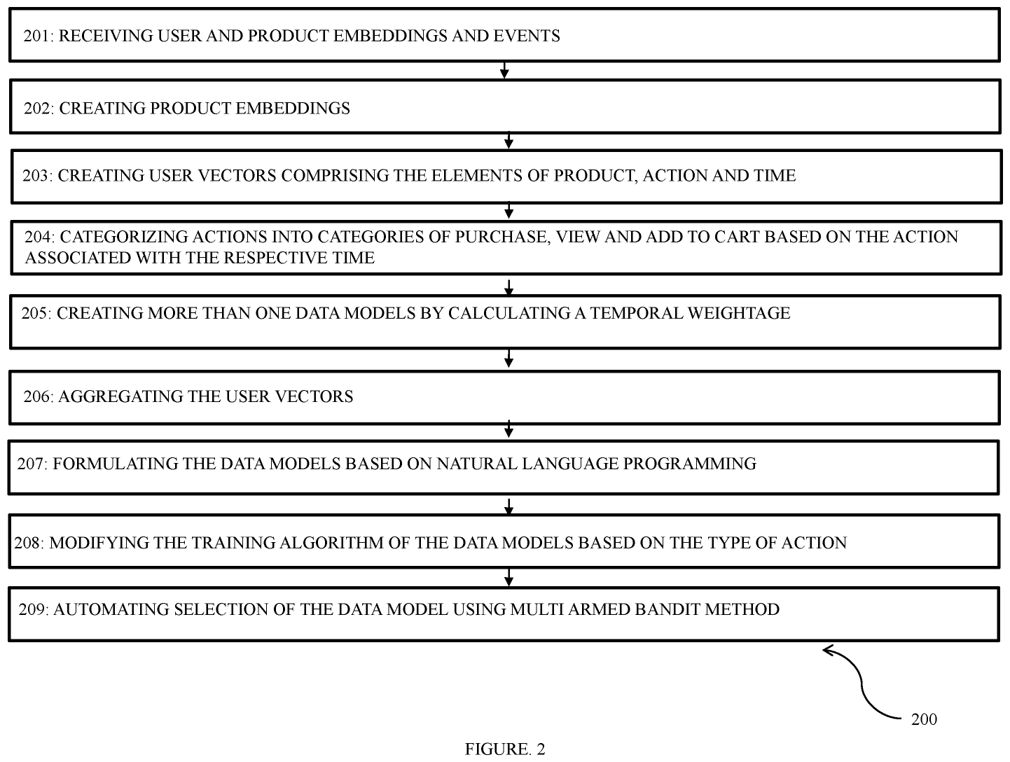

FIG. 2 illustrates a flow diagram in accordance with the present invention. At step 201, data about user and product embeddings and events is received. This data could be received from databases or third party sources in form of APIs or websites. At step 202, product embeddings are created from the data input received in step 201, for a set of products as input. At step 203, user vectors are created from the data, wherein the user vectors comprise elements of product, action, and time. An event E is defined as a tuple of (Product P, Action A, time T) wherein action (such as click or add to cart or purchase) associated with product P at time T. At step 204, the set of events E are then used to create user vectors, wherein the events are categorized into categories of purchase, view and add to cart events based on the action associated with the respective time. At step 205, multiple data models are created, based on the core concept of natural language programming based analogy. The basic structure of the data model is to take product embeddings as input, create user vectors from the embeddings and events and predict the probability of next product.

At step 206, the user vectors are aggregated. The product embeddings are learned by the model and the user vectors are an aggregation of time series of the product embeddings. The probability of next product is derived using a dot product and SoftMax for normalization. The product user embedding matrix is reused here to reduce parameter size. The following is an example of calculating event embedding:

eᵢ: [Embedding of product at i^{th} event]×one hot encoded action

where eᵢ is the event embedding for the product at event i. hot encoded action could correspond to user action such as view, add to cart or purchase. Hence, based on above example, if action is view, event embedding can be calculated as:

eᵢ=concatenate([0k; Embedding pᵢ; 0ₖ])

where eᵢ is event embedding, k is the embedding dimension and 0ₖ is a vector of zeros of size k.

The user vector aggregation is carried out using two methods. The first method uses a weighted mean such as below:

U=FCN (sum(wᵢ*eᵢ))

wherein U is user vector, FCN is the fully connected & feed forward network and eᵢ is the event embedding. wᵢ is the temporal weight, calculated as below:

wᵢ=alpha**dtᵢ

wherein alpha is the forgetting factor and dtᵢ is the time difference between event i and output event.

This method using weighted mean for user vector aggregation takes into account a temporal weight wᵢ to take into account the recency of the event. The temporal weight is a function of a forgetting factor and time difference between the event and output event. This method of data forgetting simplifies the data model by implementing the heuristics that older data might not be very relevant for predicting the next action for a product.

The second method of user vector aggregation uses sequence models, such that

U=GRU(eᵢ), U=Attention(eᵢ)).

Among these methods, weighted mean based user vector aggregation is a simpler model, as it does not require additional parameters. However, this method is less powerful than sequence models like GRU and self attention based transformers, which are more effective for capturing complex patterns in natural language programming models. However, these models are more require more data, while the weighted average models are effective even when there is not a lot of data.

The model is trained with cross entropy loss, and target as next product and appropriate temporal weights as above.

The data model in the invention is further adapted to take into account the limitations of a huge product space or for data augmentation. Data sampling can be used when the product space is huge, which is also inspired by the natural language programming models, like sampled SoftMax and negative sampling. The data augmentation is also done in analogy with natural language processing concepts, wherein random events are dropped from sequence. This implies dropout at input level, and the new sequences as a result of this dropout give additional data points, which are not very far from true distributions. The sampling helps in reducing the training time and improving the data efficiency with larger product space and augmentation helps in stabilizing the data model.

At step 207, analogy is drawn from natural language processing model, such as a Word2Vec, or a language modelling task, where the objective is to predict next token based on previous tokens of a sentence. These language processing models are adapted to recommendation systems, where the task is formulated such as to predict next event based on past activities or interests of user.

At step 208, in addition to above method of data augmentation, if there is enough data available, product wise conversion ratios are used to recommend products with higher conversion ratios. This is achieved by weighing training examples according to their type, for example:

If Actionᵢ₊₁'=purchase, loss weightage=View(Pᵢ₊₁)/Purchase(Pᵢ₊₁).

If Actionᵢ₊₁==add to cart, loss weightage=View(P₁₊₁)/Add to cart (Rᵢ₊₁)

loss weightage=1 for all other actions;

Pretraining and finetuning is performed next, where it is important to retrain models on recent trends. When recent data is not abundant, a substitute as inspired from NLP is used to pretrain for a common task and then finetune for specific task. In this case there are two possible methods. The first method involves finetuning on recent data where in the pre-training is done on complete dataset, followed by retrain/finetune with smaller learning rates on recent data for limited duration. The second method involves pretraining on events such as views/clicks to learn product similarities, then finetuning with smaller dataset of purchase events.

At step 209 multi armed bandit framework is used to finetune and optimize final recommendations from set of models. Different models work best in different scenarios and use cases. Moreover as the objective of the invention is to define a process which involves less intervention and generalizes well, multi armed bandit can be used as a solution. A small set of models is trained using the steps of the invention, wherein each model solves a unique situation or use case. For example, on e-commerce website's product display page, model with short term preferences work well, while on an e-commerce website's home page, you need long term preferences of the user. Multi armed bandit method identifies the efficacy of the data models in each of these situations and delivers accordingly. A separate multi armed bandit is implemented for each different context, wherein a context is a combination of categorical variables. Some of these variables used are webpage type, returning or non-returning user etc. A discounted Thompson sampling method is used, as it enables nonstationary estimates and it adapts dynamically to best performing variation.

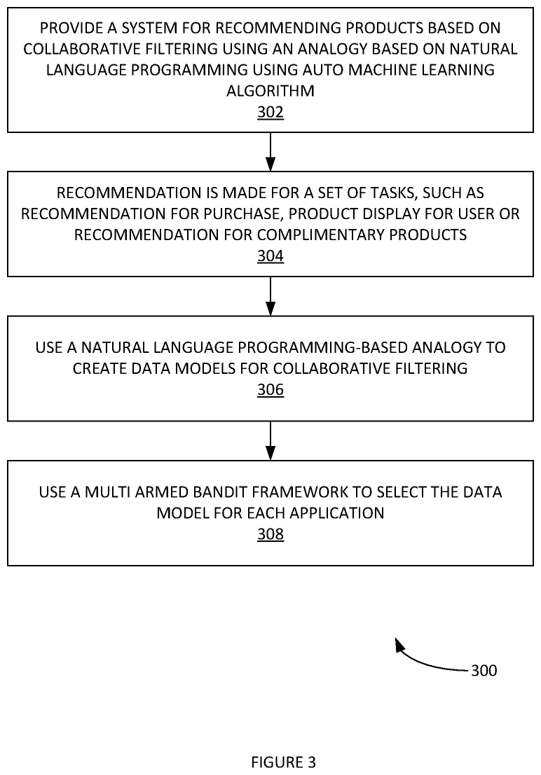

FIG. 3 illustrates another example process 300, according to some embodiments. In step 302, process 300 provides a system for recommending products based on collaborative filtering using an analogy based on natural language programming using auto machine learning algorithm. In step 304, the recommendation is made for a set of tasks, such as recommendation for purchase, product display for the user or recommendation for complimentary products. In step 306, process 300 uses a natural language programming-based analogy to create data models for collaborative filtering. In step 308, process 300 uses a multi armed bandit framework to select the data model for each application.

Machine learning (ML) can use statistical techniques to give computers the ability to learn and progressively improve performance on a specific task with data, without being explicitly programmed. Deep learning is a family of machine learning methods based on learning data representations. Learning can be supervised, semi-supervised or unsupervised. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning.

Machine learning is a type of AI that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of predicting an event associated with a user action using a machine learning process, the method comprising the steps of:
dynamically identifying a type of a task for prediction;
creating a set of product embeddings for a set of products;
creating a set of user vectors comprising one or more elements of a product, an action, and a time;
categorizing the set of user actions into one or more categories of a purchase, a view and an add to a cart based on each action associated with a respective time;
creating one more than one data models by calculating a temporal weightage based on a time difference between an event, an event output, and a forgetting factor, for training the one or more data models based on a set of categorized actions, aggregating a set of user vectors based on a feed forward network and a temporal weightage;
modifying a training algorithm of the set of data models based on a specified type of action;
formulating the one or more data models based on a natural language programming-based design wherein:
the product is modelled as a word in an analogy with the natural language programming-based design,
the user's events during a session are modelled as a sentence in the analogy with the natural language programming-based design,
the user's history is modelled as a paragraph in analogy with the natural language programming-based design,
the user session is classified in the analogy with a sentiment analysis operation in the natural language programming-based design to identify a probability of a purchase for the session, and
the data model is pretrained and finetuned based on oner or more events of the views and the clicks to identify a plurality of product similarities, finetuning the one or more model based on the events of the purchase and a recent data;
predicting a probability of a next product to be purchased or liked as an output by calculating a dot product and a SoftMax of user vectors and a set of product embeddings; and
using a multi armed bandit framework for an automating selection of each data model based on a type of task and a utilized machine learning model and optimizing a final recommendation based a selected data model.

2. The method of claim 1, further comprising the training algorithm of the data models based on a loss weightage depending upon the type of action including purchase, view or add to cart, wherein:
the loss weightage is set equal to total number of view actions/total number of purchase actions, when the action is purchase;
the loss weightage is set equal to a total number of view actions/total number of add to cart actions, when the action is added to cart; and
the loss weightage is set equal to 1 for all other actions.

3. The method of claim 1, wherein the training of the set of data models is only based on a set of view action metrics when the product recommendation on a user display matches a desired prediction.

4. The method of claim 1, wherein the training of the set of data models based on purchase actions when a complementary product recommendation during a purchase is the desired prediction.

5. The method of claim 1, further comprising calculating the user vector aggregation based on sequence models.

6. A system for predicting event associated with a user action using machine learning the system comprising:
a data receiving device for receiving data comprising product embeddings and events associated with the products and user data;
at least one processor coupled to a memory, the processor executes an algorithm that:
dynamically identifying a type of a task for prediction;
creating a set of product embeddings for a set of products;
creating a set of user vectors comprising one or more elements of a product, an action, and a time;
categorizing the set of user actions into one or more categories of a purchase, a view and an add to a cart based on each action associated with a respective time;
creating one more than one data models by calculating a temporal weightage based on a time difference between an event, an event output, and a forgetting factor, for training the one or more data models based on a set of categorized actions,
aggregating a set of user vectors based on a feed forward network and a temporal weightage;
modifying a training algorithm of the set of data models based on a specified type of action;
formulating the one or more data models based on a natural language programming-based design wherein:
the product is modelled as a word in an analogy with the natural language programming-based design,
the user's events during a session are modelled as a sentence in the analogy with the natural language programming-based design,
the user's history is modelled as a paragraph in analogy with the natural language programming-based design,
the user session is classified in the analogy with a sentiment analysis operation in the natural language programming-based design to identify a probability of a purchase for the session, and
the data model is pretrained and finetuned based on oner or more events of the views and the clicks to identify a plurality of product similarities,
finetuning the one or more model based on the events of the purchase and a recent data;
predicting a probability of a next product to be purchased or liked as an output by calculating a dot product and a SoftMax of user vectors and a set of product embeddings; and
using a multi armed bandit framework for an automating selection of each data model based on a type of task and a utilized machine learning model and optimizing a final recommendation based a selected data model.

7. The system of claim 6, wherein the training algorithm of the data models is based on a loss weightage depending upon the type of action including the purchase, the view or the add to cart.

8. The system of claim 7, wherein the loss weightage is equal to a total number of view actions and a total number of purchase actions, when the action is the purchase action.

9. The system of claim 7, wherein the loss weightage is equal to total number of view actions and a total number of add to cart actions, when the action is an add to a cart action.

10. The system of claim 7, wherein the loss weightage is equal to 1 for when the action is not added to the cart and when the action is not a purchase.

11. The method of claim 7, wherein the training the data models are only based on view actions if product recommendation on a user display is the desired prediction.

12. The method of claim 7, wherein the training the data models are based on purchase actions when a complementary product recommendation during purchase is the desired prediction.

13. The method of claim 7, wherein the user vector aggregation is calculated based on a sequence of machine-learning derived models.
